(19) United States
(12) Patent Application Publication
(10) Pub. No.: US 2017/0319410 A1
(43) Pub. Date: Nov. 9, 2017

(54) BED FOR PROMOTING GROWTH AND RELAXING JOINTS AND MUSCLES

(71) Applicant: Seungho LEE, Seogwipo-si (KR)

(72) Inventor: Seungho LEE, Seogwipo-si (KR)

(21) Appl. No.: 15/533,010

(22) PCT Filed: Dec. 3, 2015
(86) PCT No.: PCT/KR2015/013132

§ 371 Date: Jun. 2, 2017

(30) Foreign Application Priority Data
Dec. 4, 2014 (KR) 10-2014-0173070

(51) Int. Cl. A61G 7/015; A47C 23/04; A61H 15/00; A61H 1/02; A61G 7/018

(52) U.S. Cl. CPC A61G 7/015; A61H 1/0274; A61H 1/0237; A47C 23/04; A61H 15/0078; A61G 7/018; A61H 2203/0443; A61H 2205/08

(57) ABSTRACT

A bed for promoting growth and relaxing joints and muscles includes a bed mattress part and rotation roller parts on both sides of the mattress part to support a user's upper and lower body, which move the user's upper and lower body in the directions of the end of the head and the end of the toes with respect to a pelvis region to stretch the body, thereby promoting growth and relaxing the joints and muscles. The bed promotes growth, in infants, children and teenagers, by providing an artificial stimulus of stretching not only joints in which physeal plates are positioned, but also the whole body in a sleeping state; and in the case of adults whose growth period is complete, recovering joints which have been pressed due to activities such as standing or carrying heavy items, promoting blood circulation by stimulating the skin, and relaxing the muscles.

### TECHNICAL FIELD

The present invention relates to a bed, and more particularly, to a bed for promoting growth and relaxing joints and muscles.

### BACKGROUND ART

Generally, growth of infants, children, and adolescents mostly occurs during sleep. This is because growth hormones are largely secreted during sleep, and also because people do activities while walking upright, and thus their growth is considerably restricted due to gravity during activities.

In addition, in the case of adults whose growth has been completed, height differences between morning and night vary from person to person and are in the range of 1 cm to 4 cm due to the effect of gravity on the body. This is because overall height decreases due to compression of an intervertebral disc, which is the joint cartilage of the spine, and articular cartilages of knees, ankles, the femoral region, and the like, the decreased height returns to an original state during sleep, and these phenomena are repeated. In particular, when a person stands for a long period of time or lifts weights, the joints are further compressed, and thus strained, and it takes more time for the joints to restore. Thus, continuous spine strain may lead to symptoms such as a herniated disc, spinal stenosis, or the like.

Therefore, infants, children and adolescents require promotion of growth during sleep, and adults require promotion of recovery of compressed joints, promotion of blood circulation through skin stimulation, and relaxation of muscles.

### PRIOR ART DOCUMENT

(Patent document 0001) Korean Patent Application Registration No. 10-1106021 “Auxiliary device for promoting height growth”

### DISCLOSURE

### Technical Problem

Therefore, the present invention has been made in view of the above problems, and it is one object of the present invention to provide a bed for promoting growth and relaxing joints and muscles that is capable of promoting growth of infants, children, and adolescents by artificial stimulation such as stretching of the whole body as well as bones where growth plates are located, during sleep.

It is another object of the present invention to provide a bed for promoting growth and relaxing joints and muscles that is capable of restoring joints compressed when grown-ups stand for a long period of time or lift weights, promoting blood circulation by skin stimulation, and relaxing muscles.

### Technical Solution

In accordance with one aspect of the present invention, provided is a bed including: a bed mattress part; and a rotating roller part installed at opposite sides of the mattress part to support upper and lower bodies of a user, and promoting growth and relaxing joints and muscles by stretching a body through movement of the upper and lower bodies of a user in head end and toe end directions with respect to a pelvis portion.

In addition, the rotating roller part may include: a first rotating roller part provided on one side of the mattress part to support a lower surface of the upper body of the user and moving the upper body of the user in the head end direction through roller rotary motion, and a second rotating roller part installed on the other side of the mattress part to support a lower surface of the lower body of the user and moving the lower body of the user in the toe end direction through roller rotary motion.

In addition, the first rotating roller part may include: a plurality of upper body rotating rollers installed parallel to the upper body of the user and including rotary axes rotatably installed in a direction transverse to a length direction of the body of the user; and a driving motor connected to the rotary axes of the upper body rotating rollers via a belt to rotate the upper body rotating rollers.

In addition, the second rotating roller part may include: a plurality of lower body rotating rollers installed parallel to the lower body of the user and including rotary axes rotatably installed in a direction transverse to a length direction of the body of the user; and a driving motor connected to the rotary axes of the lower body rotating rollers via a belt to rotate the lower body rotating rollers.

In addition, the rotary axes of the upper body rotating rollers, the lower body rotating rollers, and the driving motor and inner circumferential surfaces of the belts may be provided with teeth to be meshed with each other.

In addition, the mattress part may include: a middle mattress between the upper body rotating rollers and the lower body rotating rollers and supporting the pelvis portion of the user; an upper body mattress installed to support a lower portion of the upper body rotating rollers; and a lower body mattress installed to support a lower portion of the lower body rotating rollers.

In addition, the first rotating roller part according to another exemplary embodiment of the present invention may include: a plurality of upper body rotating rollers installed parallel to the upper body of the user and provided with rotary axes installed so as to rotate in a direction transverse to a length direction of the body of the user, the rotary axes being provided with teeth; a plurality of middle gears installed between a pair of neighboring upper body rotating rollers and meshed to be engaged with the teeth of the upper body rotating rollers; and a driving motor connected to rotary axes of the middle gears via a belt to rotate the middle gears.

In addition, the second rotating roller part may include: a plurality of lower body rotating rollers installed parallel to the lower body of the user and provided with rotary axes installed so as to rotate in a direction transverse to a length direction of the body of the user, the rotary axes being provided with teeth; a plurality of middle gears installed between a pair of neighboring lower body rotating rollers and meshed to be meshed with the teeth of the lower body rotating rollers;

and a driving motor connected to rotary axes of the middle gears via a belt to rotate the middle gears.

In addition, the rotary axes of the middle gears, a rotary axis of the driving motor, and an inner circumferential surface of the belt are provided with teeth to be meshed with each other.

In addition, by controlling the number of the teeth of the middle gears configured to be engaged with the teeth formed at the rotary axes of the upper body rotating rollers and the lower body rotating rollers, respectively, rotational speeds of the upper body rotating rollers and the lower body rotating rollers gradually increase towards the head end and toe end of the upper and lower bodies from the pelvis portion of the user.

In addition, the first rotating roller part according to yet another exemplary embodiment of the present invention may include: a plurality of upper body rotating rollers installed parallel to the upper body of the user and provided with rotary axes installed so as to rotate in a direction transverse to a length direction of the body of the user, the rotary axes being provided with teeth; a plurality of middle gears installed between a pair of neighboring upper body rotating rollers and meshed to be engaged with the teeth of the upper body rotating rollers; and a plurality of driving motors installed to correspond to the middle gears and provided with rotary axes having teeth to be engaged with the teeth of the middle gears to rotate the middle gears.

In addition, the second rotating roller part may include: a plurality of lower body rotating rollers installed parallel to the lower body of the user and provided with rotary axes installed so as to rotate in a direction transverse to a length direction of the body of the user, the rotary axes being provided with teeth; a plurality of middle gears installed between a pair of neighboring lower body rotating rollers and meshed to be engaged with the teeth of the lower body rotating rollers; and a plurality of driving motors installed to correspond to the middle gears and provided with rotary axes having teeth to be engaged with the teeth of the middle gears to rotate the middle gears.

In addition, rotational speeds and rotation directions of the upper body rotating rollers and the lower body rotating rollers may be freely adjusted by controlling rotational speeds and rotation directions of the respective driving motors.

In addition, the upper body rotating rollers and the lower body rotating rollers may include: a roller body provided with a rotary axis at a center thereof; an elastic member surrounding an outer circumferential surface of the roller body; and a fibrous member surrounding a surface of the elastic member.

In addition, the roller body may be in a coil spring tube form.

In accordance with another aspect of the present invention, provided is a bed including: a bed mattress part; and a rotating bet part installed at opposite sides of the mattress part to support upper and lower bodies of a user, and promoting growth and relaxing joints and muscles by stretching a body through movement of the upper and lower bodies of a user in head end and toe end directions with respect to a pelvis portion

In addition, the rotating belt part may include: a first rotating belt part installed at one side of the mattress part to support a lower surface of the upper body of the user and moving the upper body of the user in a head end portion through belt rotary motion; and a second rotating belt part installed at the other side of the mattress part to support a lower surface of the lower body of the user and moving the lower body of the user in a toe end direction through belt rotary motion.

In addition, the first rotating belt part may include: two belt pulleys installed parallel to the upper body of the user and provided with rotary axes so as to rotate in a direction transverse to a length direction of the body of the user; an upper body rotating belt wound on the belt pulleys in a conveyor belt form; and a driving motor connected to the rotary axis of one of the belt pulleys via a belt to rotate the upper body rotating belt through rotary driving of the belt pulley.

In addition, the second rotating belt part may include: two belt pulleys installed parallel to the lower body of the user and provided with rotary axes so as to rotate in a direction transverse to a length direction of the body of the user; a lower body rotating belt wound on the belt pulleys in a conveyor belt form; and a driving motor connected to the rotary axis of any one of the belt pulleys via a belt to rotate the lower body rotating belt through rotary driving of the belt pulley.

In addition, the upper body rotating belt and the lower body rotating belt may be provided with uneven portions at surfaces thereof to increase friction between contact surfaces thereof with the body of the user.

In addition, the mattress part may include: a middle mattress between the upper body rotating belt and the lower body rotating belt and supporting the pelvis portion of the user; an upper body mattress installed to support a lower portion of an upper end of the inside of the upper body rotating belt; and a lower body mattress installed to support a lower portion of an upper end of the inside of the lower body rotating belt.

In accordance with yet another aspect of the present invention, provided is a bed including: a plurality of bed mattresses installed in a length direction of a body of a user; a plurality of rack gears installed below the respective mattresses; and a plurality of pinion gears installed to be engaged with the rack gears below the respective mattresses, wherein the mattresses are moved by horizontal movement of the rack gears according to rotation of the pinion gears to thereby stretch the body by moving upper and lower bodies of the user in head end and toe end directions with respect to a pelvis portion to promote growth and relax joints and muscles.

In addition, the mattresses may be configured in plural so as to subdivide mattress parts corresponding to joints of the user in a length direction of the body of the user.

### ADVANTAGEOUS EFFECTS

As is apparent from the foregoing description, in a bed for promoting growth and relaxing joints and muscles of the present invention, while upper body rotating rollers and lower body rotating rollers rotate, upper and lower bodies of a user are moved in head end and toe end directions with respect to a pelvis portion to stretch the body, whereby growth of infants, children, and adolescents is promoted by artificial stimulation such as stretching of the whole body as well as bones where growth plates are located, during sleep. In addition, the present invention may provide an effect of restoring joints compressed due to activities such as standing for a long period of time or lifting weights, promoting blood circulation by skin stimulation, and relaxing muscles, for adults. In particular, an effect of massaging a part of the body or the whole body by adjusting speed and direction of rotating rollers in the non-sleeping state may be provided.

In addition, the present invention has an effect of promoting growth and relaxing joints and muscles by stretching the body through horizontal movement of upper and lower bodies of a user in head end and toe end directions with respect to a pelvis portion while an upper body rotating belt and a lower body rotating belt rotate.

In addition, the present invention provides an effect of promoting growth and relaxing joints and muscles by stretching the body through movement of upper and lower bodies of a user in head end and toe end directions with respect to a pelvis portion, by independently moving mattresses by horizontal movement of rack gears according to rotation of pinion gears.

### DESCRIPTION OF DRAWINGS

FIG. 1 is a perspective view of a bed for promoting growth and relaxing joints and muscles according to a first embodiment of the present invention.

FIG. 2 is a side configuration view of the bed for promoting growth and relaxing joints and muscles according to a first embodiment of the present invention.

FIG. 3 illustrates a cross-sectional view of a rotating roller included in the bed according to a first embodiment of the present invention (a), a perspective view of a roller body (b), and a perspective view illustrating a structure in which the rotating roller is rotated by a notched belt (c).

FIG. 4 is a side configuration view of a bed for promoting growth and relaxing joints and muscles according to a second embodiment of the present invention.

FIG. 5 is a side configuration view of a bed for promoting growth and relaxing joints and muscles according to a third embodiment of the present invention.

FIG. 6 is a perspective view of a bed for promoting growth and relaxing joints and muscles according to a fourth embodiment of the present invention.

FIG. 7 is a side configuration view of the bed for promoting growth and relaxing joints and muscles according to a fourth embodiment of the present invention.

FIG. 8 is a perspective view of a bed for promoting growth and relaxing joints and muscles according to a fifth embodiment of the present invention.

FIG. 9 is a side configuration view of the bed for promoting growth and relaxing joints and muscles according to a fifth embodiment of the present invention.

### BEST MODE

The advantages, characteristics, and technical solutions of the present invention will be clearly understood with reference to embodiments described below in detail together with the accompanying drawings. However, the present invention should not be construed as being limited to embodiments set forth herein and may be embodied in many different forms. Rather, these embodiments are provided so that this disclosure will be complete, and will fully convey the scope of the invention to those of ordinary skill in the art, and the present invention is merely defined by the scope of the claims.

Hereinafter, beds for promoting growth and relaxing joints and muscles according to exemplary embodiments of the present invention will be described in detail with reference to the accompanying drawings. In the description of the present invention, detailed explanations of related known functions or configurations are omitted when it is deemed that they may unnecessarily obscure the essence of the invention.

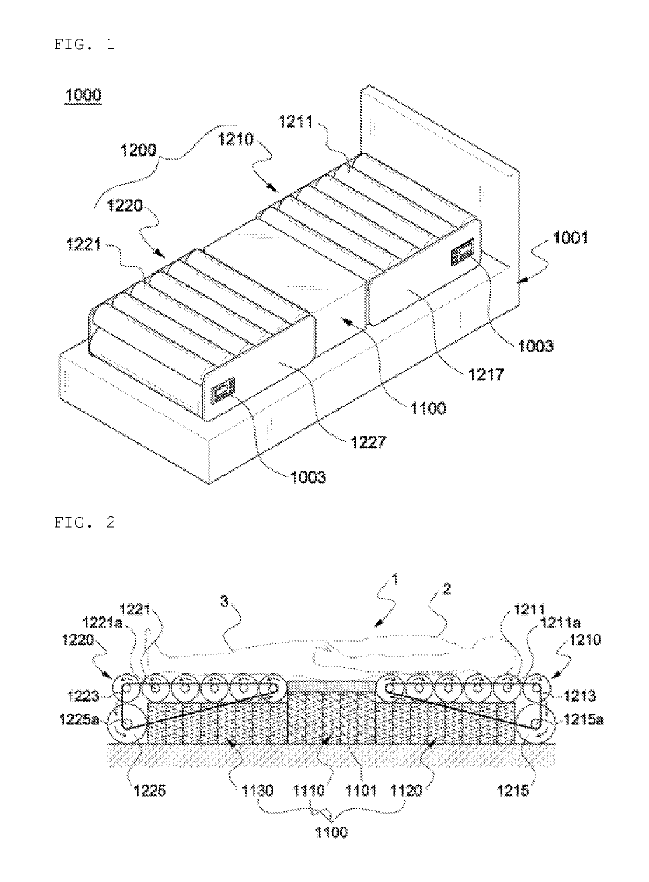

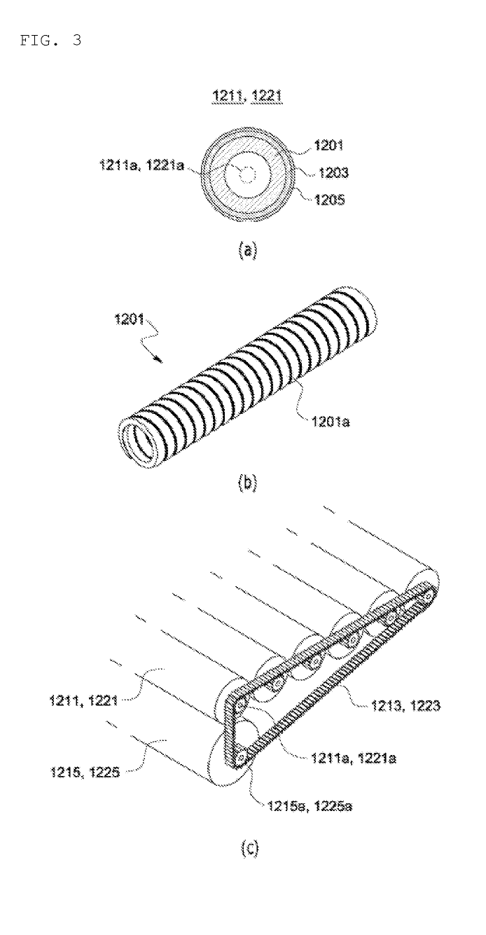

FIG. 1 is a perspective view of a bed 1000 for promoting growth and relaxing joints and muscles according to a first embodiment of the present invention. FIG. 2 is a side configuration view of the bed 1000 for promoting growth and relaxing joints and muscles according to a first embodiment of the present invention.

As illustrated in FIGS. 1 and 2, the bed 1000 for promoting growth and relaxing joints and muscles according to a first embodiment of the present invention may include a bed mattress part 1100 and a rotating roller part 1200.

The bed mattress part 1100 is installed on an upper portion of a bed frame 1001. The mattress part 1100 is provided with a plurality of coil springs 1101 installed upright therein to elastically support the body of a user 1, and the coil springs 1101 may be in a pocket spring form so as to provide the user 1 with comfort without horizontal shaking. The mattress part 1100 can be understood as a commonly known mattress, and thus a detailed description thereof will not be provided herein. The mattress part 1100 may include a middle mattress 1110 installed between first and second rotating roller parts 1210 and 1220, which will be described below, to support buttocks and a pelvis portion of the user 1.

The rotating roller part 1200 is installed at opposite sides of the mattress part 1100 to support an upper body 2 and a lower body 3 of the user 1. The rotating roller part 1200 stretches the body by moving the upper and lower bodies 2 and 3 of the user 1 in head end and toe end directions with respect to the pelvis portion, thereby promoting growth and relaxing joints and muscles. The rotating roller part 1200 may include the first rotating roller part 1210 that is provided on one side of the mattress part 1100 to support a lower surface of the upper body 2 of the user 1 and moves the upper body 2 of the user 1 in a head end direction through roller rotary motion, and the second rotating roller part 1220 that is installed on the other side of the mattress part 1100 to support a lower surface of the lower body 3 of the user 1 and moves the lower body 3 of the user 1 in a toe end direction through roller rotary motion. The first rotating roller part 1210 may include a plurality of upper body rotating rollers 1211 installed parallel to the upper body 2 of the user 1 and including rotary axes 1211a rotatably installed in a direction transverse to a length direction of the body of the user 1 and a driving motor 1215 connected to the rotary axes 1211a of the upper body rotating rollers 1211 via a belt 1213 to rotate the upper body rotating rollers 1211. In addition, although not shown in the drawings, a reduction gear connected to a rotary axis 1215a of the driving motor 1215 may be further provided and the belt 1213 may be connected to the reduction gear, and, through such a configuration, a rotational speed of the upper body rotating roller 1211 may be appropriately adjusted. The rotary axes 1211a of the upper body rotating rollers 1211 and the rotary axis 1215a of the driving motor 1215 are rotatably supported by a fixing panel 1217 installed at a side surface of the first rotating roller part 1210. In this regard, the fixing panel 1217 supports the rotary axes 1211a of the upper body rotating rollers 1211 so as to be vertically spaced apart from each other with a constant interval therebetween, thereby imparting elasticity to the upper body rotating rollers 1211. Alternatively, the fixing panel 1217 itself may elastically support the upper body rotating roller 1211 so as to vertically space the upper body rotating rollers apart from each other with a constant interval therebetween. In addition, an upper body mattress 1120 may be provided to support a lower portion of the upper body rotating rollers 1211. The second rotating roller part 1220 may include a plurality of lower body rotating rollers 1221 installed parallel to a lower body 3 of the user 1 and including rotary axes 1221a rotatably installed in a direction transverse to a length direction of the body of the user 1, and a driving motor 1225 connected to the rotary axes 1221a of the lower body rotating rollers 1221 via a belt 1223 to rotate the lower body rotating rollers 1221. In addition, although not shown in the drawings, a reduction gear connected to a rotary axis 1225a of the driving motor 1225 may be further provided and the belt 1223 may be connected to the reduction gear, and, through such a configuration, a rotational speed of the lower body rotating roller 1221 may be appropriately adjusted. The rotary axes 1221a of the lower body rotating rollers 1221 and the rotary axis 1225a of the driving motor 1225 are rotatably supported by a fixing panel 1227 installed at a side surface of the second rotating roller part 1220. In this regard, the fixing panel 1227 supports the rotary axes 1221a of the lower body rotating rollers 1221 so as to be vertically spaced apart from each other with a constant interval therebetween, thereby imparting elasticity to the lower body rotating rollers 1221. Alternatively, the fixing panel 1227 itself may elastically support the lower body rotating roller 1221 so as to vertically space the upper body rotating rollers apart from each other with a constant interval therebetween. In addition, a lower body mattress 1130 may be installed to support a lower portion of the lower body rotating rollers 1221. Rotation direction, rotational speed, and the like of each of the upper body rotating rollers 1211 and the lower body rotating rollers 1221 may be adjusted by a control panel 1003 installed at one side of the bed or a remote control.

FIG. 3 illustrates a cross-sectional view of a rotating roller included in the bed according to a first embodiment of the present invention (a), a perspective view of a roller body (b), and a perspective view illustrating a structure in which the rotating roller is rotated by a notched belt (c).

As illustrated in FIG. 3(a), each of the upper body rotating roller 1211 and the lower body rotating roller 1221 may include a roller body 1201 provided with a roller rotary axis 1211a or 1221a at the center thereof and having a cylindrical shape, an elastic member 1203 surrounding an outer circumferential surface of the roller body 1201 and formed of an elastic material, e.g., sponge, latex, memory foam, or the like, and a fibrous member 1205 surrounding a surface of the elastic member 1203 and formed of a material that does not irritate the skin even when in direct contact therewith, e.g., cotton or fiber in a towel form. In addition, although not shown in the drawings, the upper and lower body rotating rollers 1211 and 1221 may further include thermal and vibration functions, thereby maximizing an effect of promoting growth and relaxing joints and muscles. Such a roller structure having thermal and vibration functions can be understood as the known technique, and thus a detailed description thereof will not be provided herein. In addition, the rotation direction, rotational speed, and the like of the upper body rotating roller 1211 and the lower body rotating roller 1221 may be adjusted by controlling rotation driving of the driving motors 1215 and 1225, and the size or number of rollers may be adjusted according to body conditions of the user 1, e.g., body height. In addition, the roller body 1201 may have a hollow cylindrical tube shape or a solid round rod shape, but the present invention is not limited thereto. As illustrated in FIG. 3(b), the roller body 1201 may be formed as a coil spring tube 1201a so as to elastically support the body of the user. In addition, the roller body 1201 may have an elastic tube or rod shape, in addition to the coil spring tube shape. In addition, as illustrated in FIG. 3(c), the rotary axes 1211a and 1221a of the upper body rotating rollers 1211 and the lower body rotating rollers 1221, the rotary axes 1215a and 1225a of the driving motors 1215 and 1225, and inner circumferential surfaces of the belts 1213 and 1223 may be provided with teeth. Accordingly, when the driving motors 1215 and 1225 are driven for rotary motion, the teeth formed at the rotary axes 1215a and 1225a of the driving motors 1215 and 1225 are engaged with the teeth formed at the inner circumferential surfaces of the belts 1213 and 1223 to rotate the belts 1213 and 1223 in an endless track, and the teeth of the belts 1213 and 1223 are engaged with the teeth formed at the rotary axes 1211a and 1221a of the upper body rotating rollers 1211 and the lower body rotating rollers 1221 to rotate the upper body rotating rollers 1211 and the lower body rotating roller 1221.

In the bed 1000 for promoting growth and relaxing joints and muscles according to a first embodiment of the present invention, having the above-described structure, when the upper body rotating rollers 1211 are rotated in one direction, for example, clockwise as illustrated in FIG. 2, the upper body 2 of the user 1 is horizontally moved in a head end direction by rotary motion of the upper body rotating rollers 1211. In addition, simultaneously with rotation of the upper body rotating rollers 1211, when the lower body rotating rollers 1221 are rotated in a direction opposite to the rotation direction of the upper body rotating rollers 1211, for example, counterclockwise as illustrated in FIG. 2, the lower body 3 of the user 1 is horizontally moved in a toe end direction by rotary motion of the lower body rotating rollers 1221. That is, while the upper and lower body rotating rollers 1211 and 1221 rotate, the upper and lower bodies 2 and 3 of the user 1 are moved in the head end and toe end directions with respect to the pelvis portion, thereby stretching the body. Thus, an effect of promoting growth of infants, children, and adolescents by artificial stimulation, such as stretching of the whole body as well as bones where growth plates are located, during sleep, is provided. Furthermore, an indirect effect of promoting growth by restoring joints that have been compressed due to gravity during activities and promoting blood circulation through skin stimulation may also be provided. In addition, the present invention may provide an effect of restoring joints compressed due to activities such as standing for a long period of time and lifting weights, promoting blood circulation by skin stimulation, and relaxing muscles, for adults.

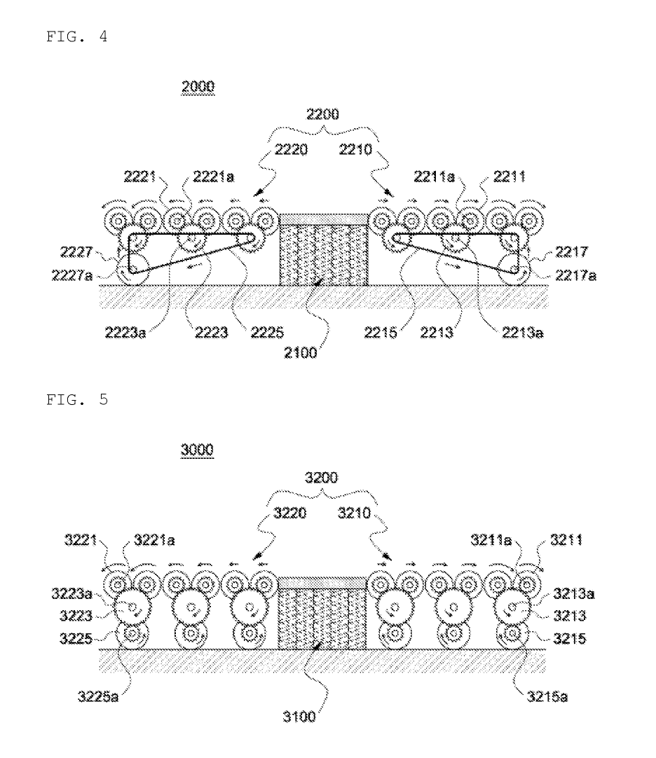

FIG. 4 is a side configuration view of a bed 2000 for promoting growth and relaxing joints and muscles according to a second embodiment of the present invention.

As illustrated in FIG. 4, the bed 2000 for promoting growth and relaxing joints and muscles according to a second embodiment of the present invention includes a bed mattress part 2100 and a rotating roller part 2200, and the second embodiment is the same as the first embodiment described with reference to FIGS. 1 to 3 except for the rotating roller part 2200. Thus, a detailed description of elements having the same function as that of the first embodiment, i.e., the bed mattress part 2100, will be omitted, and only the rotating roller part 2200 having a structure different from that of the first embodiment will now be described in detail.

The rotating roller part 2200 is installed at opposite sides of the mattress part 2100 so as to support the upper and lower bodies 2 and 3 of the user 1. The rotating roller part 2200 may include a first rotating roller part 2210 installed at one side of the mattress part 2100 to support a lower surface of the upper body 2 of the user 1 and moving the upper body 2 of the user 1 in a head end direction through rotary motion of rollers, and a second rotating roller part 2220 installed at the other side of the mattress part 2100 to support the lower surface of the lower body 3 of the user 1 and moving the lower body 3 of the user 1 in a toe end direction through rotary motion of rollers. The first rotating roller part 2210 may include a plurality of upper body rotating rollers 2211 installed parallel to the upper body 2 of the user 1 and provided with rotary axes 2211a installed so as to rotate in a direction transverse to a length direction of the body of the user 1, the rotary axes 2211a being provided with teeth, a plurality of middle gears 2213 installed between a pair of neighboring upper body rotating rollers 2211 and meshed with the teeth of the upper body rotating rollers 2211, and a driving motor 2217 connected to rotary axes 2213a of the middle gears 2213 via a belt 2215 to rotate the middle gears 2213. The second rotating roller part 2220 may include a plurality of lower body rotating rollers 2221 installed parallel to the lower body 3 of the user 1 and provided with rotary axes 2221a so as to rotate in a direction transverse to a length direction of the body of the user 1, the rotary axes 2221a being provided with teeth, a plurality of middle gears 2223 installed between a pair of neighboring lower body rotating rollers 2221 and meshed with the teeth of the lower body rotating rollers 2221, and a driving motor 2227 connected to rotary axes 2223a of the middle gears 2223 via a belt 2225 to rotate the middle gears 2223. Although not shown in the drawings, an upper body mattress and a lower body mattress may be installed to support lower portions of the upper body rotating rollers 2211 and the lower body rotating rollers 2221, respectively. In addition, although not shown in the drawings, the rotary axes 2213a and 2223a of the middle gears 2213 and 2223, the rotary axes 2217a and 2227a of the driving motors 2217 and 2227, and inner circumferential surfaces of the belts 2215 and 2225 may be provided with teeth. Accordingly, when the driving motors 2217 and 2227 are driven for rotary motion, the teeth formed at the rotary axes 2217a and 2227a of the driving motors 2217 and 2227 are engaged with the teeth formed at the inner circumferential surfaces of the belts 2215 and 2225 to rotate the belts 2215 and 2225 in an endless track, and the teeth of the belts 2215 and 2225 are engaged with the teeth formed at the rotary axes 2213a and 2223a of the middle gears 2213 and 2223 to rotate the middle gears 2213 and 2223, thereby rotating the upper body rotating rollers 2211 and the lower body rotating rollers 2221 engaged with the teeth of the middle gears 2213 and 2223.

The bed 2000 for promoting growth and relaxing joints and muscles according to a second embodiment of the present invention, having the above-described configuration, has an effect of promoting growth and relaxing joints and muscles by stretching the body through movement of the upper and lower bodies 2 and 3 of the user 1 in head end and toe end directions with respect to the pelvis portion while the upper body rotating rollers 2211 and the lower body rotating rollers 2221 rotate. In particular, by controlling the number of the teeth of the middle gears 2213 and 2223 configured to be engaged with the teeth formed at the rotary axes of the upper body rotating rollers 2211 and the lower body rotating rollers 2221, respectively, rotational speeds of the upper body rotating rollers 2211 and the lower body rotating rollers 2221 may gradually increase towards the head end and toe end of the upper and lower bodies 2 and 3 from the pelvis portion of the user 1, whereby the effect of promoting growth and relaxing joints and muscles may be further enhanced. For example, when the number of teeth formed at the rotary axes 2211a of the upper body rotating rollers 2211 is identical to that of the rotary axes 2221a of the lower body rotating rollers 2221, and the number of teeth of the middle gears 2213 and 2223 increases towards the head and toe ends of the upper and lower bodies 2 and 3 from the pelvis portion of the user 1, a ratio of teeth formed at the upper and lower body rotating rollers 2211 and 2221 to teeth formed at the middle gears 2213 and 2223 increases, and thus rotational speeds of the upper and lower body rotating rollers 2211 and 2221 gradually increase towards the head end of the upper body 2 and the toe end of the lower body 3.

FIG. 5 is a side configuration view of a bed 3000 for promoting growth and relaxing joints and muscles according to a third embodiment of the present invention.

As illustrated in FIG. 5, the bed 3000 for promoting growth and relaxing joints and muscles according to a third embodiment of the present invention includes a bed mattress part 3100 and a rotating roller part 3200, and the third embodiment is the same as the second embodiment described with reference to FIG. 4 except for the rotating roller part 3200. Thus, a detailed description of elements having the same function as that of the second embodiment, i.e., the bed mattress part 3100, will be omitted, and only the rotating roller part 3200 having a structure different from that of the second embodiment will now be described in detail.

The rotating roller part 3200 is installed at opposite sides of the mattress part 3100 so as to support the upper and lower bodies 2 and 3 of the user 1. The rotating roller part 3200 may include a first rotating roller part 3210 installed at one side of the mattress part 3100 to support a lower surface of the upper body 2 of the user 1 and moving the upper body 2 of the user 1 in a head end direction through rotary motion of rollers, and a second rotating roller part 3220 installed at the other side of the mattress part 3100 to support the lower surface of the lower body 3 of the user 1 and moving the lower body 3 of the user 1 in a toe end direction through rotary motion of rollers. The first rotating roller part 3210 may include a plurality of upper body rotating rollers 3211 installed parallel to the upper body 2 of the user 1 and provided with rotary axes 3211a installed so as to rotate in a direction transverse to a length direction of the body of the user 1, the rotary axes 3211a being provided with teeth, a plurality of middle gears 3213 installed between a pair of neighboring upper body rotating rollers 3211 and meshed with the teeth of the upper body rotating rollers 3211, and a plurality of driving motors 3215 installed to correspond to the middle gears 3213 and provided with rotary axes 3215a having teeth to be engaged with the teeth of the middle gears 3213 to rotate the middle gears 3213. The second rotating roller part 3220 may include a plurality of lower body rotating rollers 3221 installed parallel to the lower body 3 of the user 1 and provided with rotary axes 3221a so as to rotate in a direction transverse to a length direction of the body of the user 1, the rotary axes 3221a being provided with teeth, a plurality of middle gears 3223 installed between a pair of neighboring lower body rotating rollers 3221 and meshed with the teeth of the lower body rotating rollers 3221, and a plurality of driving motors 3225 installed to correspond to the middle gears 3223 and including rotary axes 3225a provided with teeth to be engaged with the teeth of the meddle gears 3223 to rotate the middle gears 3223.

The bed 3000 for promoting growth and relaxing joints and muscles according to a third embodiment of the present invention, having the above-described configuration, has an effect of promoting growth and relaxing joints and muscles by stretching the body through movement of the upper and lower bodies 2 and 3 of the user 1 in head end and toe end directions with respect to the pelvis portion while the upper body rotating rollers 3211 and the lower body rotating rollers 3221 rotate. In particular, rotational speeds and rotation directions of the upper body rotating rollers 3211 and the lower body rotating rollers 3221 may be freely adjusted by individually controlling rotational speeds and rotation directions of the driving motors 3215 and 3225. As a result, an effect of massaging the body of a user may be maximized by adjusting rotational speeds and rotation directions of rotating rollers according to sites of the body in the non-sleeping state or during activities.

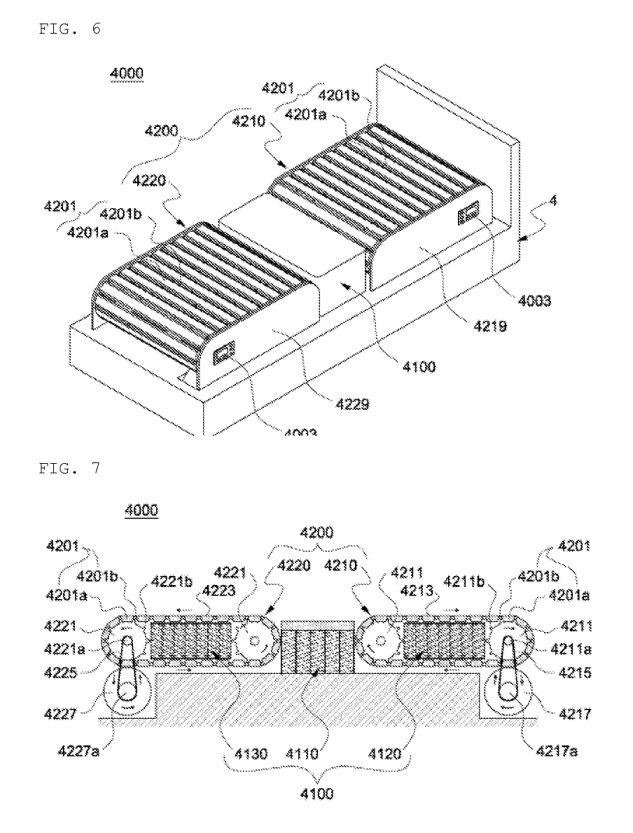

FIG. 6 is a perspective view of a bed for promoting growth and relaxing joints and muscles according to a fourth embodiment of the present invention. FIG. 7 is a side configuration view of the bed for promoting growth and relaxing joints and muscles according to a fourth embodiment of the present invention.

As illustrated in FIGS. 6 and 7, the bed 4000 for promoting growth and relaxing joints and muscles according to a fourth embodiment of the present invention may include a bed mattress part 4100 and a rotating belt part 4200.

The bed mattress part 4100 is installed on an upper portion of a bed frame 4001. The mattress part 4100 may include a middle mattress 4110 installed between first and second rotating belt parts 4210 and 4220, which will be described below, to support buttocks and a pelvis portion of a user.

The rotating belt part 4200 is installed at opposite sides of the mattress part 4100 to support the upper and lower bodies 2 and 3 of the user 1. The rotating belt part 4200 serves to promote growth and relax joints and muscles by stretching the body through movement of the upper and lower bodies 2 and 3 of the user 1 in head end and toe end directions with respect to the pelvis portion. The rotating belt part 4200 may include a first rotating belt part 4210 installed at one side of the mattress part 4100 to support a lower surface of the upper body 2 of the user 1 and moving the upper body 2 of the user 1 in a head end direction through belt rotary motion, and a second rotating belt part 4220 installed at the other side of the mattress part 4100 to support a lower surface of the lower body 3 of the user 1 and moving the lower body 3 of the user 1 in a toe end direction through belt rotary motion. The first rotating belt part 4210 may include two belt pulleys 4211 installed parallel to the upper body 2 of the user 1 and provided with rotary axes 4211a so as to rotate in a direction transverse to a length direction of the body of the user 1, an upper body rotating belt 4213 wound on the belt pulleys 4211 in a conveyor belt form, and a driving motor 4217 connected to the rotary axis 4211a of one of the belt pulleys 4211 via a belt 4215 to rotate the upper body rotating belt 4213 through rotary driving of the belt pulley 4211. The rotary axes 4211a of the belt pulleys 4211 and a rotary axis 4217a of the driving motor 4217 are rotatably supported by a fixing panel 4219 installed at a side surface of the first rotating belt part 4210. In addition, an upper body mattress 4120 may be installed to support a lower portion of an upper end of the inside of the upper body rotating belt 4213. The second rotating belt part 4220 may include two belt pulleys 4221 installed parallel to the lower body 3 of the user 1 and provided with rotary axes 4221a so as to rotate in a direction transverse to a length direction of the body of the user 1, a lower body rotating belt 4223 wound on the belt pulleys 4221 in a conveyor belt form, and a driving motor 4227 connected to the rotary axis 4221a of any one of the belt pulleys 4221 via a belt 4225 to rotate the lower body rotating belt 4223 through rotary driving of the belt pulley 4221. The rotary axes 4221a of the belt pulleys 4221 and a rotary axis 4227a of the driving motor 4227 are rotatably supported by a fixing panel 4229 installed at a side surface of the second rotating belt part 4220. In addition, a lower body mattress 4130 may be installed to support a lower portion of an upper end of the inside of the lower body rotating belt 4223. In addition, the upper and lower body rotating belts 4213 and 4223 may be provided with uneven portions 4201 at surfaces thereof to increase friction between contact surfaces thereof with the body of the user. For example, the uneven portion 4201 may be formed at the surface of each of the upper and lower body rotating belts 4213 and 4223 such that convex portions 4201a and concave portions 4201b are consecutively formed along a movement direction of the corresponding belt. Although not shown in the drawing, the upper body rotating belt 4213 and the lower body rotating belt 4223 may include an elastic part, and, for example, the elastic part may include a belt body, an elastic member covering a surface of the belt body and formed of an elastic material, such as sponge, latex, memory foam, or the like, and a fibrous member covering a surface of the elastic member and formed of a material that does not irritate the skin even when in direct contact therewith, such as cotton or fiber in a towel form. In addition, the belt pulleys 4211 and 4221 may be provided, at outer circumferential surfaces thereof, with a plurality of protrusions 4211b and 4221b to be engaged with the concave portions 4201b of each of the upper and lower body rotating belts 4213 and 4223 so that the belt pulleys 4211 and 4221 rotate while being engaged with the upper body rotating belt 4213 and the lower body rotating belt 4223. In addition, although not shown in the drawing, the rotary axes 4211a and 4221a of the belt pulleys 4211 and 4221, the rotary axes 4217a and 4227a of the driving motors 4217 and 4227, and inner circumferential surfaces of the belts 4215 and 4225 may be provided with teeth. Accordingly, when the driving motors 4217 and 4227 are driven for rotary motion, the teeth formed at the rotary axes 4217a and 4227a of the driving motors 4217 and 4227 are engaged with the teeth formed at the inner circumferential surfaces of the belts 4215 and 4225 to rotate the belts 4215 and 4225 in an endless track, and the teeth of the belts 4215 and 4225 are engaged with the teeth formed at the rotary axes 4211a and 4221a of the belt pulleys 4211 and 4221 to rotate the belt pulleys 4211 and 4221, thereby rotating the upper body rotating belt 4213 and the lower body rotating belt 4223. In addition, rotation directions, rotational speeds, and the like of the upper body rotating belt 4213 and the lower body rotating belt 4223 may be adjusted by a control panel 4003 installed at one side of the bed or using a remote control.

In the bed 4000 for promoting growth and relaxing joints and muscles according to a fourth embodiment of the present invention, having the above-described structure, when the upper body rotating belt 4213 is rotated in one direction, for example, clockwise as illustrated in FIG. 7, the upper body 2 of the user 1 is horizontally moved in a head end direction by conveyor rotary motion of the upper body rotating belt 4213. In addition, simultaneously with rotation of the upper body rotating belt 4213, when the lower body rotating belt 4223 is rotated in a direction opposite to the rotation direction of the upper body rotating belt 4213, for example, counterclockwise as illustrated in FIG. 7, the lower body 3 of the user 1 is horizontally moved in a toe end direction by conveyor rotary motion of the lower body rotating belt 4223. That is, there is provided an effect of promoting growth and relaxing joints and muscles by stretching the body through horizontal movement of the upper and lower bodies 2 and 3 of the user 1 in head end and toe end directions with respect to the pelvis portion while the upper body rotating belt 4213 and the lower body rotating belt 4223 rotate.

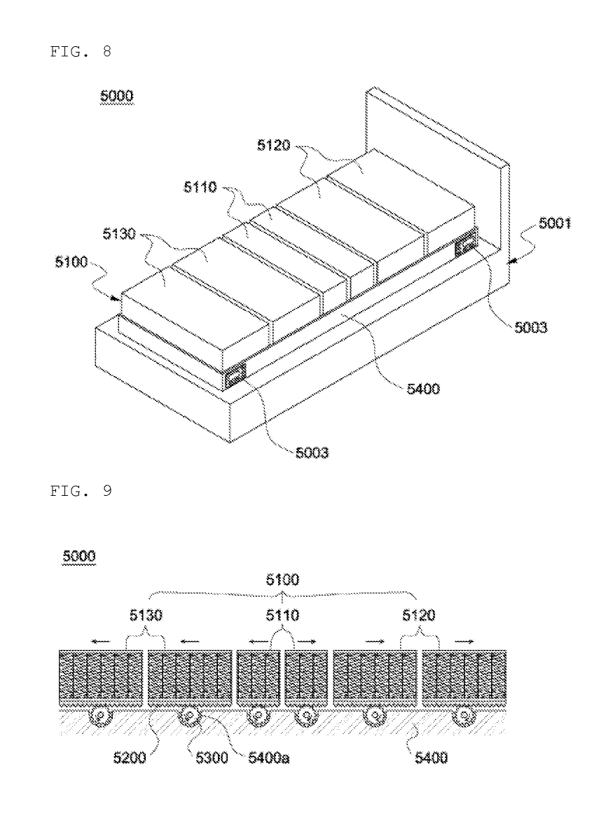

FIG. 8 is a perspective view of a bed 5000 for promoting growth and relaxing joints and muscles according to a fifth embodiment of the present invention. FIG. 9 is a side configuration view of the bed for promoting growth and relaxing joints and muscles according to a fifth embodiment of the present invention.

As illustrated in FIGS. 8 and 9, the bed 5000 for promoting growth and relaxing joints and muscles according to a fifth embodiment of the present invention may include a plurality of bed mattresses 5100, rack gears 5200, and pinion gears 5300.

The bed mattresses 5100 are installed on an upper portion of a bed frame 5001 in a length direction of the body of the user 1. The mattresses 5100 may be separated from each other in an independent form, or, although not shown in the drawing, the mattresses 5100 may be connected to each other via a connection member in a folding form or a spring form. In addition, the mattresses 5100 may be disposed so as to subdivide mattress parts corresponding to joints of the user in a length direction of the body of the user. For example, the mattresses 5100 may be subdivided such that the length in a body direction of the mattress 5100 that supports a joint portion of the waist of the user 1 is much shorter than the length in a body direction of the mattress 5100 that supports a thigh or calf portion of the user 1.

The rack gears 5200 are installed below the respective mattresses 5100 in a horizontal gear form.

The pinion gears 5300 are installed below the respective mattresses 5100 in a circular gear form to be engaged with the rack gears 5200. The pinion gears 5300 are rotatably installed at gear mounting grooves 5400a formed in a lower frame 5400 to be respectively inserted thereinto. A rotation direction, rotational speed, and the like of each pinion gear 5300 may be adjusted by a control panel 5003 installed at one side of the bed or using a remote control.

The rack gears 5200 and the pinion gears 5300, which are gear devices that convert rotary motion to horizontal movement (or vice versa), are known techniques, and thus a detailed description thereof will be omitted.

In the bed 5000 for promoting growth and relaxing joints and muscles according to a fifth embodiment of the present invention, having the above-described configuration, the mattresses 5100 may be independently moved by horizontal movement of the rack gears 5200 according to rotation of the pinion gears 5300. As such, there is provided an effect of promoting growth and relaxing joints and muscles by stretching the body through movement of the upper and lower bodies 2 and 3 of the user 1 in head end and toe end directions with respect to the pelvis portion when the mattresses 5100 are moved.

While embodiments of the present invention have been described with reference to the accompanying drawings, it will be understood by those of ordinary skill in the art to which the present invention pertains that the invention may be carried out in other specific forms without changing technical spirits or essential characteristics of the present invention. Thus, the embodiments described herein are provided only for illustrative purposes and not for purposes of limitation. The scope of the present invention is defined by the following claims rather than the detailed description, and all changes or modified forms derived from the meaning and scope of the claims, and concepts equivalent thereto should be construed as being within the scope of the present invention.

1. A bed comprising:
a bed mattress part; and
a rotating roller part installed at opposite sides of the mattress part to support upper and lower bodies of a user, and promoting growth and relaxing joints and muscles by stretching a body through movement of the upper and lower bodies of a user in head end and toe end directions with respect to a pelvis portion.

2. The bed according to claim 1, wherein the rotating roller part comprises:
a first rotating roller part provided on one side of the mattress part to support a lower surface of the upper body of the user and moving the upper body of the user in the head end direction through roller rotary motion; and
a second rotating roller part installed on the other side of the mattress part to support a lower surface of the lower body of the user and moving the lower body of the user in the toe end direction through roller rotary motion.

3. The bed according to claim 2, wherein the first rotating roller part comprises:
a plurality of upper body rotating rollers installed parallel to the upper body of the user and comprising rotary axes rotatably installed in a direction transverse to a length direction of the body of the user; and
a driving motor connected to the rotary axes of the upper body rotating rollers via a belt to rotate the upper body rotating rollers.

4. The bed according to claim 3, wherein the second rotating roller part comprises:
a plurality of lower body rotating rollers installed parallel to the lower body of the user and comprising rotary axes rotatably installed in a direction transverse to a length direction of the body of the user; and
a driving motor connected to the rotary axes of the lower body rotating rollers via a belt to rotate the lower body rotating rollers.

5. The bed according to claim 4, wherein the rotary axes of the upper body rotating rollers, the lower body rotating rollers, and the driving motor, and inner circumferential surfaces of the belts are provided with teeth to be meshed with each other.

6. The bed according to claim 4, wherein the mattress part comprises:
a middle mattress between the upper body rotating rollers and the lower body rotating rollers and supporting the pelvis portion of the user;
an upper body mattress installed to support a lower portion of the upper body rotating rollers; and
a lower body mattress installed to support a lower portion of the lower body rotating rollers.

7. The bed according to claim 2, wherein the first rotating roller part comprises:
a plurality of upper body rotating rollers installed parallel to the upper body of the user and provided with rotary axes installed so as to rotate in a direction transverse to a length direction of the body of the user, the rotary axes being provided with teeth;
a plurality of middle gears installed between a pair of neighboring upper body rotating rollers and meshed to be engaged with the teeth of the upper body rotating rollers; and
a driving motor connected to rotary axes of the middle gears via a belt to rotate the middle gears.

8. The bed according to claim 7, wherein the second rotating roller part comprises:
a plurality of lower body rotating rollers installed parallel to the lower body of the user and provided with rotary axes installed so as to rotate in a direction transverse to a length direction of the body of the user, the rotary axes being provided with teeth;
a plurality of middle gears installed between a pair of neighboring lower body rotating rollers and meshed with the teeth of the lower body rotating rollers; and
a driving motor connected to rotary axes of the middle gears via a belt to rotate the middle gears.

9. The bed according to claim 8, wherein the rotary axes of the middle gears and the driving motor, and an inner circumferential surface of the belt are provided with teeth to be meshed with each other.

10. The bed according to claim 8, wherein, by controlling the number of the teeth of the middle gears configured to be engaged with the teeth formed at the rotary axes of the upper body rotating rollers and the lower body rotating rollers, respectively, rotational speeds of the upper body rotating rollers and the lower body rotating rollers gradually increase towards the head end and toe end of the upper and lower bodies from the pelvis portion of the user.

11. The bed according to claim 2, wherein the first rotating roller part comprises:
a plurality of upper body rotating rollers installed parallel to the upper body of the user and provided with rotary axes installed so as to rotate in a direction transverse to a length direction of the body of the user, the rotary axes being provided with teeth;
a plurality of middle gears installed between a pair of neighboring upper body rotating rollers and meshed with the teeth of the upper body rotating rollers; and
a plurality of driving motors installed to correspond to the middle gears and provided with rotary axes having teeth to be engaged with the teeth of the middle gears to rotate the middle gears.

12. The bed according to claim 11, wherein the second rotating roller part comprises:
a plurality of lower body rotating rollers installed parallel to the lower body of the user and provided with rotary axes installed so as to rotate in a direction transverse to a length direction of the body of the user, the rotary axes being provided with teeth;
a plurality of middle gears installed between a pair of neighboring lower body rotating rollers and meshed with the teeth of the lower body rotating rollers; and
a plurality of driving motors installed to correspond to the middle gears and provided with rotary axes having teeth to be engaged with the teeth of the middle gears to rotate the middle gears.

13. The bed according to claim 12, wherein rotational speeds and rotation directions of the upper body rotating rollers and the lower body rotating rollers are freely adjusted by controlling rotational speeds and rotation directions of the respective driving motors.

14. The bed according to claim 4, wherein the upper body rotating rollers and the lower body rotating rollers comprise: a roller body provided with a rotary axis at a center thereof; an elastic member covering an outer circumferential surface of the roller body; and a fibrous member covering a surface of the elastic member.

15. The bed according to claim 14, wherein the roller body is in a coil spring tube form.

16. A bed comprising:
a bed mattress part; and
a rotating belt part installed at opposite sides of the mattress part to support upper and lower bodies of a user, and promoting growth and relaxing joints and muscles by stretching a body through movement of the upper and lower bodies of a user in head end and toe end directions with respect to a pelvis portion.

17. The bed according to claim 16, wherein the rotating belt part comprises:
a first rotating belt part installed at one side of the mattress part to support a lower surface of the upper body of the user and moving the upper body of the user in the head end portion through belt rotary motion; and
a second rotating belt part installed at the other side of the mattress part to support a lower surface of the lower body of the user and moving the lower body of the user in the toe end direction through belt rotary motion.

18. The bed according to claim 17, wherein the first rotating belt part comprises:
two belt pulleys installed parallel to the upper body of the user and provided with rotary axes so as to rotate in a direction transverse to a length direction of the body of the user; an upper body rotating belt wound on the belt pulleys in a conveyor belt form; and
a driving motor connected to the rotary axis of any one of the belt pulleys via a belt to rotate the upper body rotating belt through rotary driving of the belt pulley.

19. The bed according to claim 18, wherein the second rotating belt part comprises:
two belt pulleys installed parallel to the lower body of the user and provided with rotary axes so as to rotate in a direction transverse to a length direction of the body of the user; a lower body rotating belt wound on the belt pulleys in a conveyor belt form; and
a driving motor connected to the rotary axis of any one of the belt pulleys via a belt to rotate the lower body rotating belt through rotary driving of the belt pulley.

20. The bed according to claim 19, wherein the upper body rotating belt and the lower body rotating belt are provided with uneven portions at surfaces thereof to increase friction between contact surfaces thereof with the body of the user.

21. The bed according to claim 19, wherein the mattress part comprises:
a middle mattress between the upper body rotating belt and the lower body rotating belt and supporting the pelvis portion of the user;
an upper body mattress installed to support a lower portion of an upper end of the inside of the upper body rotating belt; and
a lower body mattress installed to support a lower portion of an upper end of the inside of the lower body rotating belt.

22. A bed comprising:
a plurality of bed mattresses installed in a length direction of a body of a user;
a plurality of rack gears installed below the respective mattresses; and
a plurality of pinion gears installed to be engaged with the rack gears below the respective mattresses, wherein the mattresses are moved by horizontal movement of the rack gears according to rotation of the pinion gears to thereby stretch the body by moving upper and lower bodies of the user in head end and toe end directions with respect to a pelvis portion to promote growth and relax joints and muscles.

23. The bed according to claim 22, wherein the mattresses are configured in plural so as to subdivide mattress parts corresponding to joints of the user in a length direction of the body of the user.
